(19) United States
(12) Patent Application Publication
(10) Pub. No.: US 2020/0128218 A1
(43) Pub. Date: Apr. 23, 2020

(54) Projection device with automatic spot correction

(71) Applicant: Mega 1 Company Limited, New Taipei City (TW)

(72) Inventor: Cheng-Yuan LIU, New Taipei City (TW)

(21) Appl. No.: 16/424,526

(22) Filed: May 29, 2019

(30) Foreign Application Priority Data
Oct. 17, 2018 (TW) 107136601

(51) Int. Cl. H04N 9/31; G02B 26/10; G02B 27/10

(52) U.S. Cl. CPC H04N 9/3185; G02B 26/101; G02B 27/108; H04N 9/3164; H04N 9/3135; H04N 9/312; H04N 9/3194; H04N 9/3111

(57) ABSTRACT

A projection device with automatic spot correction includes an image generation unit, a light sensor, and a controller. The image generation unit outputs a light beam to scan to generate an image. The light sensor senses the light beam to obtain a spot position formed on the light sensor. The controller is coupled to the image generation unit and the light sensor. When executing an automatic spot correction procedure, the controller calculates an offset value of the spot position and uses an adjustment mechanism to correct the spot position.

### BACKGROUND OF THE INVENTION

### 1. Field of the Invention

The invention relates to a projection device and, more particularly, to a projection device with automatic spot correction.

### 2. Description of the Prior Art

An image generation unit of a conventional projection device includes a light source system and a scanning mirror. The light source system includes a red light source, a green light source, and a blue light source. The red light source, the green light source, and the blue light source output light beams having respective brightness (or grayscales) to the scanning mirror. The light beams are reflected by the scanning mirror to project on a projection screen to generate spots to mix to form a colored pixel. The scanning mirror rotates to cause the reflected light beams to be scanned on the projection screen to sequentially generate colored pixels. Because the scanning speed is extremely fast, human eyes perceive that the sequentially generated pixels appear at the same time to compose an image. However, with external forces or aging, the light beams of the red, green, and blue light sources will inevitably be offset, and accordingly the spots generated on the projection screen will be offset, resulting that the image composed of the pixels is blurred, so correction is required. A conventional spot correction used for the projection device needs to use a program to set correction modes and execute the spot correction of the red, green, and blue light sources by human eyes. It wastes time and has bad correction accurateness.

### SUMMARY OF THE INVENTION

The invention is adapted to provide a projection device with automatic spot correction, which saves time and has good correction accurateness.

According to an aspect of the invention, there is provided a projection device with automatic spot correction. The projection device includes an image generation unit, a light sensor, and a controller. The image generation unit outputs a light beam to scan to generate an image. The light sensor senses the light beam to obtain a spot position formed on the light sensor. The controller is coupled to the image generation unit and the light sensor. When executing an automatic spot correction procedure, the controller calculates an offset value of the spot position and uses an adjustment mechanism to correct the spot position.

According to another aspect of the invention, the projection device further includes a housing and a transparent cover. The housing has an opening. The transparent cover covers the opening. The image generation unit and the controller are disposed in the housing. The light sensor is disposed on the transparent cover.

According to another aspect of the invention, the projection device further includes a beam splitter. The beam splitter is inserted in a traveling path of the light beam. The beam splitter splits the light beam to obtain an auxiliary light beam traveling along an auxiliary path. The light sensor is inserted in the auxiliary path.

According to another aspect of the invention, the image generation unit includes colored light sources and a scanning mirror. Each of the colored light sources outputs the light beam to the scanning mirror to scan to generate the image.

According to another aspect of the invention, the adjustment mechanism includes: the controller sequentially enabling the colored light sources to obtain the spot position of the light beam outputted by each of the colored light sources; based on the spot position corresponding to one of the colored light sources, calculating the offset value of the spot position corresponding to each of the others of the colored light sources; and, controlling the scanning mirror to correct the spot position according to the corresponding offset value.

According to another aspect of the invention, the adjustment mechanism includes: the controller sequentially enabling the colored light sources to obtain the spot position of the light beam outputted by each of the colored light sources; based on a default spot position, calculating the offset value of the spot position of the light beam outputted by each of the colored light sources; and, controlling the scanning mirror to correct the spot position according to the corresponding offset value.

According to another aspect of the invention, the colored light sources include a red light source, a green light source, and a blue light source.

According to another aspect of the invention, the scanning mirror includes a micro-electro-mechanical-systems (MEMS) scanning mirror.

According to another aspect of the invention, the automatic spot correction procedure is automatically executed during an initialization process when starting the projection device.

According to another aspect of the invention, the automatic spot correction procedure is manually executed by operating a user interface (UI) when the projection device works normally.

In summary, by the light sensor sensing the light beam outputted by the image generation unit to obtain the spot position formed on the light sensor, when executing the automatic spot correction procedure, the controller calculates the offset value of the spot position and uses the adjustment mechanism to correct the spot position. It saves time and has good correction accurateness.

The above and other objectives, features, and advantages of the invention will be better understood from the following detailed description of the preferred embodiments of the invention that are illustrated in the accompanying drawings.

### BRIEF DESCRIPTION OF THE DRAWINGS

FIG. 1 is a structural schematic diagram of a projection device with automatic spot correction according to an embodiment of the invention.

FIG. 2 is an appearance schematic diagram of a projection device with automatic spot correction according to an embodiment of the invention.

FIG. 3 is a schematic diagram showing automatic spot correction according to an embodiment of the invention.

FIG. 4 is a schematic diagram showing automatic spot correction according to another embodiment of the invention.

FIG. 5 is a structural schematic diagram of a projection device with automatic spot correction according to another embodiment of the invention.

### DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale or shape. For purposes of convenience and clarity only, directional terms, such as up, down, left, right, front, and back may be used with respect to the drawings. These and similar directional terms should not be construed to limit the scope of the invention in any manner.

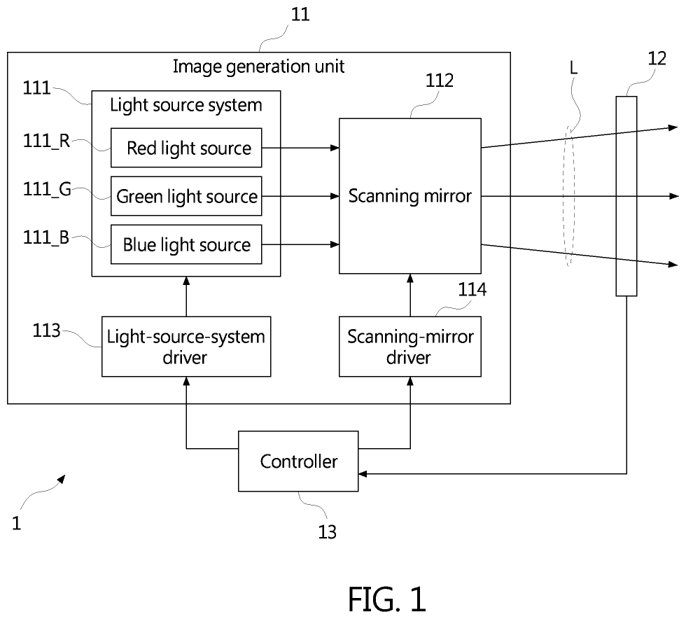

Referring to FIG. 1, FIG. 1 is a structural schematic diagram of a projection device 1 with automatic spot correction according to an embodiment of the invention. The projection device 1 includes an image generation unit 11, a light sensor 12, and a controller 13. The image generation unit 11 outputs a light beam L to scan to generate an image. The light sensor 12 is inserted in a traveling path of the light beam L, so that the light beam L travels through the light sensor 12. The light sensor 12 senses the light beam L to obtain a spot position formed on the light sensor 12. The controller 13 is coupled to the image generation unit 11 and the light sensor 12. When executing an automatic spot correction procedure, the controller 13 calculates an offset value of the spot position and uses an adjustment mechanism to correct the spot position.

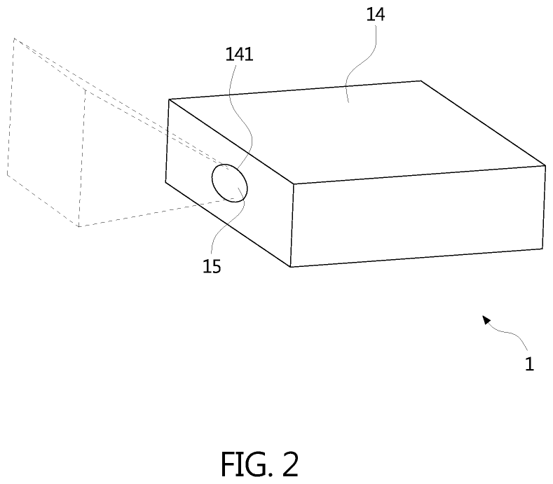

Referring to FIG. 1 and FIG. 2, FIG. 2 is an appearance schematic diagram of a projection device 1 with automatic spot correction according to an embodiment of the invention. The projection device 1 further includes a housing 14 and a transparent cover 15. The housing 14 has an opening 141. The transparent cover 15 covers the opening 141. The image generation unit 11 and the controller 13 are disposed in the housing 14. The light beam L outputted by the image generation unit 11 travels through the transparent cover 15 and projects on a projection screen (not shown) in front of the projection device 1 to scan to generate the image. The light sensor 12 is disposed on the transparent cover 15, so that the light sensor 12 is inserted in the traveling path of the light beam L outputted by the image generation unit 11.

Referring to FIG. 1 again, in the embodiment, the image generation unit 11 includes a light source system 111 and a scanning mirror 112. The light source system 111 includes colored light sources including a red light source 111_R, a green light source 111_G, and a blue light source 111_B. In an embodiment, the red light source 111_R, the green light source 111_G, and the blue light source 111_B use laser diodes. The scanning mirror 112 includes, for example, a MEMS scanning mirror. In an embodiment, the scanning mirror 112 may use a two-axis-type MEMS scanning mirror which may rotate about x-axis and y-axis.

In another embodiment, the scanning mirror 112 may use two single-axis-type MEMS scanning mirrors, one of which may rotate about x-axis and the other of which may rotate about y-axis.

The image generation unit 11 further includes a light-source-system driver 113 and a scanning-mirror driver 114. The light-source-system driver 113 is coupled between the light source system 111 and the controller 13, and the scanning-mirror driver 114 is coupled between the scanning mirror 112 and the controller 13. The controller 13 controls the light-source-system driver 113 to drive the light source system 111 to cause the red light source 111_R, the green light source 111_G, and the blue light source 111_B to output light beams having respective brightness (or grayscales) to the scanning mirror 112. The light beams are reflected by the scanning mirror 112 to project on the projection screen to generate spots to mix to form a colored pixel. The controller 13 controls the scanning-mirror driver 114 to drive the scanning mirror 112 to rotate to cause the light beams reflected by the scanning mirror 112 to be scanned on the projection screen to sequentially generate colored pixels. Because the scanning speed is extremely fast, human eyes perceive that the sequentially generated pixels appear at the same time to compose the image.

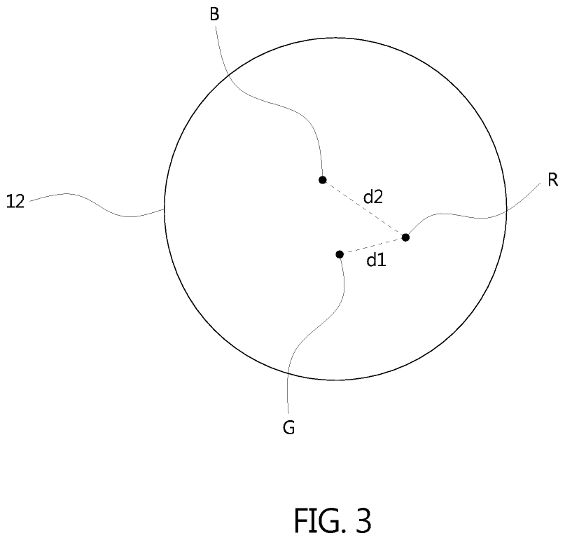

Referring to FIG. 1 and FIG. 3, FIG. 3 is a schematic diagram showing automatic spot correction according to an embodiment of the invention. In the embodiment, the automatic spot correction uses an adjustment mechanism including: the controller 13 sequentially enabling the colored light sources to obtain the spot position of the light beam outputted by each of the colored light sources; based on the spot position corresponding to one of the colored light sources, calculating the offset value of the spot position corresponding to each of the others of the colored light sources; and, controlling the scanning mirror 112 to correct the spot position according to the corresponding offset value.

Specifically, first, the controller 13 enables the red light source 111_R, and the light sensor 12 senses the light beam outputted by the red light source 111_R to obtain a spot position R formed on the light sensor 12, so that afterward the controller 13 may calculate, based on the spot position R, the offset value of the spot position corresponding to each of the others of the colored light sources. Next, the controller 13 enables the green light source 111_G, and the light sensor 12 senses the light beam outputted by the green light source 111_G to obtain a spot position G formed on the light sensor 12, so that the controller 13 may calculate an offset value d1 of the spot position G with respect to the spot position R to control the scanning mirror 112 to correct the spot position G. Finally, the controller 13 enables the blue light source 111_B, and the light sensor 12 senses the light beam outputted by the blue light source 111_B to obtain a spot position B formed on the light sensor 12, so that the controller 13 may calculate an offset value d2 of the spot position B with respect to the spot position R to control the scanning mirror 112 to correct the spot position B.

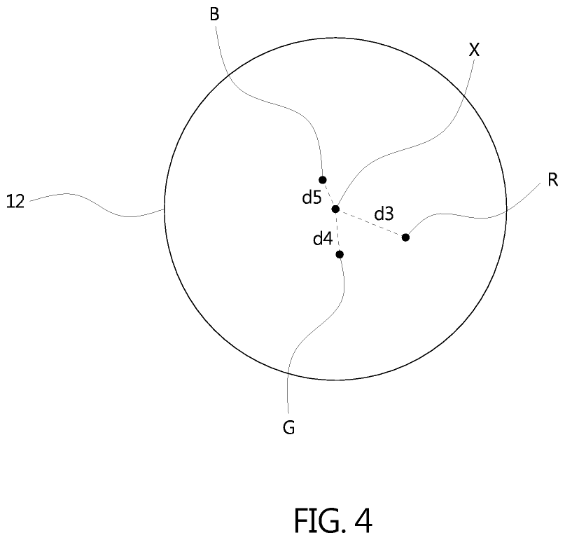

Referring to FIG. 1 and FIG. 4, FIG. 4 is a schematic diagram showing automatic spot correction according to another embodiment of the invention. In the embodiment, the automatic spot correction uses another adjustment mechanism including: the controller 13 sequentially enabling the colored light sources to obtain the spot position of the light beam outputted by each of the colored light sources; based on a default spot position X, calculating the offset value of the spot position of the light beam outputted by each of the colored light sources; and, controlling the scanning mirror 112 to correct the spot position according to the corresponding offset value. The default spot position X may be preset by the manufacturer before the projection device 1 is launched from the factory.

Specifically, first, the controller 13 enables the red light source 111_R, and the light sensor 12 senses the light beam outputted by the red light source 111_R to obtain a spot position R formed on the light sensor 12, so that the controller 13 may calculate an offset value d3 of the spot position R with respect to the default spot position X to control the scanning mirror 112 to correct the spot position R. Next, the controller 13 enables the green light source 111_G, and the light sensor 12 senses the light beam outputted by the green light source 111_G to obtain a spot position G formed on the light sensor 12, so that the controller 13 may calculate an offset value d4 of the spot position G with respect to the default spot position X to control the scanning mirror 112 to correct the spot position G. Finally, the controller 13 enables the blue light source 111_B, and the light sensor 12 senses the light beam outputted by the blue light source 111_B to obtain a spot position B formed on the light sensor 12, so that the controller 13 may calculate an offset value d5 of the spot position B with respect to the default spot position X to control the scanning mirror 112 to correct the spot position B.

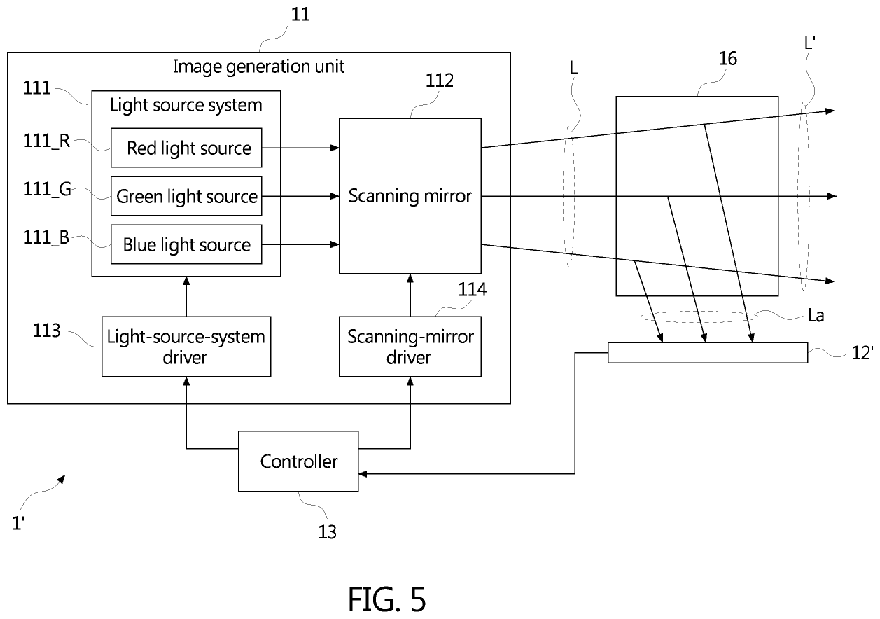

Referring to FIG. 5, FIG. 5 is a structural schematic diagram of a projection device 1′ with automatic spot correction according to another embodiment of the invention. Compared with the projection device 1 as shown in FIG. 1, the projection device 1′ as shown in FIG. 5 further includes a beam splitter 16. The beam splitter 16 is inserted in a traveling path of the light beam L outputted by the image generation unit 11, so that the light beam L travels through the beam splitter 16. The beam splitter 16 splits the light beam L into an auxiliary light beam La and a light beam L′, in which the auxiliary light beam La travels along an auxiliary path while the light beam L′ travels along the traveling path of the light beam L to project on the projection screen. In addition, compared with the projection device 1 as shown in FIG. 1, the light sensor 12′ of the projection device 1′ as shown in FIG. 5 is changed to be inserted in the auxiliary path, so that the auxiliary light beam La travels through the light sensor 12′. The light sensor 12′ senses the auxiliary light beam La obtain a spot position formed on the light sensor 12′.

In an embodiment, the automatic spot correction procedure is automatically executed during an initialization process when starting the projection device 1. In another embodiment, the projection device 1 provides a user interface (UI) for a user to set the automatic spot correction procedure. For example, when the projection device 1 works normally, the user may operate the UI to manually execute the automatic spot correction procedure. In addition, the user may operate the UI to turn off the function of automatically executing the automatic spot correction procedure during the initialization process.

In summary, by the light sensor sensing the light beam outputted by the image generation unit to obtain the spot position formed on the light sensor, when executing the automatic spot correction procedure, the controller calculates the offset value of the spot position and uses the adjustment mechanism to correct the spot position. It saves time and has good correction accurateness.

Although the invention has been described in terms of the preferred embodiments, it is not limited thereto. It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A projection device with automatic spot correction, comprising:
an image generation unit outputting a light beam to scan to generate an image;
a light sensor sensing the light beam to obtain a spot position formed on the light sensor; and
a controller coupled to the image generation unit and the light sensor, with when executing an automatic spot correction procedure, the controller calculating an offset value of the spot position and using an adjustment mechanism to correct the spot position.

2. The projection device of claim 1, wherein the projection device further comprises a housing and a transparent cover, with the housing having an opening, with the transparent cover covering the opening; and wherein the image generation unit and the controller are disposed in the housing, with the light sensor disposed on the transparent cover.

3. The projection device of claim 1, wherein the projection device further comprises a beam splitter inserted in a traveling path of the light beam, with the beam splitter splitting the light beam to obtain an auxiliary light beam traveling along an auxiliary path; and wherein the light sensor is inserted in the auxiliary path.

4. The projection device of claim 1, wherein the image generation unit comprises a plurality of colored light sources and a scanning mirror, with each of the plurality of colored light sources outputting the light beam to the scanning mirror to scan to generate the image.

5. The projection device of claim 4, wherein the adjustment mechanism includes: the controller sequentially enabling the plurality of colored light sources to obtain the spot position of the light beam outputted by each of the plurality of colored light sources; based on the spot position corresponding to one of the plurality of colored light sources, calculating the offset value of the spot position corresponding to each of the others of the plurality of colored light sources; and, controlling the scanning mirror to correct the spot position according to the corresponding offset value.

6. The projection device of claim 4, wherein the adjustment mechanism includes: the controller sequentially enabling the plurality of colored light sources to obtain the spot position of the light beam outputted by each of the plurality of colored light sources; based on a default spot position, calculating the offset value of the spot position of the light beam outputted by each of the plurality of colored light sources; and, controlling the scanning mirror to correct the spot position according to the corresponding offset value.

7. The projection device of claim 4, wherein the plurality of colored light sources comprise a red light source, a green light source, and a blue light source.

8. The projection device of claim 4, wherein the scanning mirror comprises a micro-electro-mechanical-systems (MEMS) scanning mirror.

9. The projection device of claim 1, wherein the automatic spot correction procedure is automatically executed during an initialization process when starting the projection device.

10. The projection device of claim 1, wherein the automatic spot correction procedure is manually executed by operating a user interface when the projection device works normally.
